(19) United States
(12) Patent Application Publication
(10) Pub. No.: US 2015/0149157 A1
(43) Pub. Date: May 28, 2015

(54) FREQUENCY DOMAIN GAIN SHAPE ESTIMATION

(71) Applicant: QUALCOMM Incorporated, San Diego, CA (US)

(72) Inventors: Venkatraman S. Atti, San Diego, CA (US); Venkata Subrahmanyam Chandra Sekhar Chebiyyam, San Diego, CA (US); Venkatesh Krishnan, San Diego, CA (US); Stephane Pierre Villette, San Diego, CA (US)

(21) Appl. No.: 14/550,737

(22) Filed: Nov. 21, 2014

Related U.S. Application Data
(60) Provisional application No. 61/907,923, filed on Nov. 22, 2013.

(51) Int. Cl. G10L 19/02; G10L 19/26

(52) U.S. Cl. CPC G10L 19/0204; G10L 19/265
USPC 704/205

(57) ABSTRACT

A method includes determining, at a speech encoder, frequency domain gain shape parameters. The frequency domain gain shape parameters are based on a second signal associated with an audio signal. The method further includes adjusting a first signal based on the frequency domain gain shape parameters. The first signal is associated with the audio signal. The method also includes inserting the frequency domain gain shape parameters into an encoded version of the audio signal to enable gain adjustment during reproduction of the audio signal from the encoded version of the audio signal.

### I. CLAIM OF PRIORITY

The present application claims priority from U.S. Provisional Patent Application No. 61/907,923 entitled “FREQUENCY DOMAIN GAIN SHAPE ESTIMATION,” filed Nov. 22, 2013, the contents of which are incorporated by reference in their entirety.

### II. FIELD

The present disclosure is generally related to signal processing.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet Protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player.

In traditional telephone systems (e.g., public switched telephone networks (PSTNs)), signal bandwidth is limited to the frequency range of 300 Hertz (Hz) to 3.4 kiloHertz (kHz). In wideband (WB) applications, such as cellular telephony and voice over internet protocol (VoIP), signal bandwidth may span the frequency range from 50 Hz to 7 kHz. Super wideband (SWB) coding techniques support bandwidth that extends up to around 16 kHz. Extending signal bandwidth from narrowband telephony at 3.4 kHz to SWB telephony of 16 kHz may improve the quality of signal reconstruction, intelligibility, and naturalness.

SWB coding techniques typically involve encoding and transmitting the lower frequency portion of the signal (e.g., 50 Hz to 7 kHz, also called the “low-band”). For example, the low-band may be represented using filter parameters and/or a low-band excitation signal. However, in order to improve coding efficiency, the higher frequency portion of the signal (e.g., 7 kHz to 16 kHz, also called the “high-band”) may not be fully encoded and transmitted. Instead, a receiver may utilize signal modeling to predict the high-band. In some implementations, data associated with the high-band may be provided to the receiver to assist in the prediction. Such data may be referred to as “side information,” and may include gain information, line spectral frequencies (LSFs, also referred to as line spectral pairs (LSPs)), etc. Properties of the low-band signal may be used to generate the side information; however, energy disparities between the low-band and the high-band may result in side information that inaccurately characterizes the high-band.

### IV. SUMMARY

Systems and methods for performing frequency domain gain shape estimation for improved tracking of high-band temporal characteristics are disclosed. A speech encoder may use a “target” signal of an audio signal to generate information (e.g., side information) used to reconstruct a high-band portion of the audio signal at a decoder. Examples of the target signal may include a harmonically extended version of a low-band excitation of the audio signal, a high-band excitation of the audio signal, or a synthesized high-band portion of the audio signal.

A frequency domain gain shape estimator may utilize domain transformation (e.g., Fast Fourier Transform (FFT)) to determine sub-band energy differences between the target signal and a reference signal that is representative of the audio signal. For example, the target signal and the reference signal may be comprised of multiple tiles. Each tile may correspond to a particular sub-band of a particular frame (or sub-frame) of a signal (e.g., the target signal and/or the reference signal). Sub-bands may be uniform in bandwidth or non-uniform in bandwidth to enable concentrated gain shaping at particular frequency levels (e.g., frequency levels within the human auditory range). Performing an FFT operation on the target signal and the reference signal may generate a FFT representation of the target signal and a FFT representation of the reference signal. Each FFT coefficient of the FFT representations may correspond to an energy level of a particular tile of the target signal and/or the reference signal.

The frequency domain gain shape estimator may determine an energy level ratio of a tile of the target signal and a corresponding tile of the reference signal. A frequency domain gain shape adjuster may adjust the energy level of the tile of the target signal based on data (e.g., frequency domain gain shape parameters) from the frequency domain gain shape estimator to model the target signal based on the reference signal. The frequency domain gain shape parameters may be transmitted to the decoder along with other side information to assist the decoder in reconstructing the high-band portion of the audio signal.

In a particular aspect, a method includes determining frequency domain gain shape parameters at a speech decoder. The frequency domain gain shape parameters are based on a second signal associated with an audio signal. The second signal may be a high-band residual signal or a high-band portion of the audio signal (e.g., a high-band signal). The method further includes adjusting a first signal based on the frequency domain gain shape parameters. The first signal may be associated with the audio signal. The first signal may be a harmonically extended signal, a high-band excitation signal, or a synthesized high-band signal. The method also includes inserting the frequency domain gain shape parameters into an encoded version of the audio signal to enable gain adjustment during reproduction of the audio signal from the encoded version of the audio signal. Gain adjustment includes adjusting an energy level of the first signal to approximate the energy level of the second signal to enable improved reconstruction of the high-band portion of the audio signal. For example, the decoder may reconstruct the high-band portion of the audio signal using the first signal as a reference.

In another particular aspect, an apparatus includes a frequency domain gain shape estimator configured to determine frequency domain gain shape parameters. The frequency domain gain shape parameters are based on a second signal associated with an audio signal. The second signal may be a high-band residual signal or a high-band portion of the audio signal (e.g., a high-band signal). The apparatus also includes a frequency domain gain shape adjuster configured to adjust a first signal based on the frequency domain gain shape parameters. The first signal may be associated with the audio signal. The first signal may be a harmonically extended signal, a high-band excitation signal, or a synthesized high-band signal. The apparatus also includes a multiplexer configured to insert the frequency domain gain shape parameters into an encoded version of the audio signal to enable gain adjustment during reproduction of the audio signal from the encoded version of the audio signal. Gain adjustment includes adjusting an energy level of the first signal to approximate the energy level of the second signal to enable improved reconstruction of the high-band portion of the audio signal. For example, the decoder may reconstruct the high-band portion of the audio signal using the first signal as a reference.

In another particular aspect, a non-transitory computer readable medium includes instructions that, when executed by a processor, cause the processor to determine frequency domain gain shape parameters. The frequency domain gain shape parameters are based on a second signal associated with an audio signal. The second signal may be a high-band residual signal or a high-band portion of the audio signal (e.g., a high-band signal). The instructions are also executable to cause the processor to adjust a first signal based on the frequency domain gain shape parameters. The first signal may be a harmonically extended signal, a high-band excitation signal, or a synthesized high-band signal. The instructions are also executable to cause the processor to insert the frequency domain gain shape parameters into an encoded version of the audio signal to enable gain adjustment during reproduction of the audio signal from the encoded version of the audio signal. Gain adjustment includes adjusting an energy level of the first signal to approximate the energy level of the second signal to enable improved reconstruction of the high-band portion of the audio signal. For example, the decoder may reconstruct the high-band portion of the audio signal using the first signal as a reference.

In another particular aspect, an apparatus includes means for determining frequency domain gain shape parameters. The frequency domain gain shape parameters are based on a second signal associated with an audio signal. The second signal may be a high-band residual signal or a high-band portion of the audio signal (e.g., a high-band signal). The apparatus also includes means for adjusting a first signal based on the frequency domain gain shape parameters. The first signal may be a harmonically extended signal, a high-band excitation signal, or a synthesized high-band signal. The apparatus also includes means for inserting the frequency domain gain shape parameters into an encoded version of the audio signal to enable gain adjustment during reproduction of the audio signal from the encoded version of the audio signal. Gain adjustment includes adjusting an energy level of the first signal to approximate the energy level of the second signal to enable improved reconstruction of the high-band portion of the audio signal. For example, the decoder may reconstruct the high-band portion of the audio signal using the first signal as a reference.

In another particular aspect, a method includes receiving, at a speech decoder, an encoded audio signal from a speech encoder. The encoded audio signal includes frequency domain gain shape parameters. The frequency domain gain shape parameters are used to adjust a first signal associated with an audio signal, and the frequency domain gain shape parameters are based on a second signal associated with the audio signal. The first signal may be a harmonically extended signal, a high-band excitation signal, or a synthesized high-band signal. The second signal may be a high-band residual signal or a high-band portion of the audio signal (e.g., a high-band signal). The method also includes reproducing the audio signal from the encoded audio signal based on the frequency domain gain shape parameters.

In another particular aspect, an apparatus includes a speech decoder configured to receive an encoded audio signal from a speech encoder. The encoded audio signal includes frequency domain gain shape parameters. The frequency domain gain shape parameters are used to adjust a first signal associated with an audio signal, and the frequency domain gain shape parameters are based on a second signal associated with the audio signal. The first signal may be a harmonically extended signal, a high-band excitation signal, or a synthesized high-band signal. The second signal may be a high-band residual signal or a high-band portion of the audio signal (e.g., a high-band signal). The speech decoder is further configured to reproduce the audio signal from the encoded audio signal based on the frequency domain gain shape parameters.

In another particular aspect, an apparatus includes means for receiving an encoded audio signal from a speech encoder. The encoded audio signal includes frequency domain gain shape parameters. The frequency domain gain shape parameters are used to adjust a first signal associated with an audio signal, and the frequency domain shape parameters are based on a second signal associated with the audio signal. The first signal may be a harmonically extended signal, a high-band excitation signal, or a synthesized high-band signal. The second signal may be a high-band residual signal or a high-band portion of the audio signal (e.g., a high-band signal). The apparatus also includes means for reproducing the audio signal from the encoded audio signal based on the frequency domain gain shape parameters.

In another particular aspect, a non-transitory computer readable medium includes instructions that, when executed by a processor, cause the processor to receive an encoded audio signal from a speech encoder. The encoded audio signal includes frequency domain gain shape parameters. The frequency domain gain shape parameters are used to adjust a first signal associated with an audio signal, and the frequency domain gain shape parameters are based on a second signal associated with the audio signal. The first signal may be a harmonically extended signal, a high-band excitation signal, or a synthesized high-band signal. The second signal may be a high-band residual signal or a high-band portion of the audio signal (e.g., a high-band signal). The instructions are also executable to cause the processor to reproduce the audio signal from the encoded audio signal based on the frequency domain gain shape parameters.

Particular advantages provided by at least one of the disclosed embodiments include improving energy correlation between a target signal and a reference signal in a frequency domain (e.g., on a band-by-band basis) by approximating an energy level of a particular sub-band of the target signal with an energy level of a corresponding sub-band of the reference signal. Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a diagram to illustrate a particular embodiment of a system that is operable to determine frequency domain gain shape parameters for high-band reconstruction;

FIG. 2 is a diagram to illustrate particular embodiments of a frequency domain gain shape estimator and a frequency domain gain shape adjuster;

FIG. 3 is a diagram of a particular embodiment of a spectrogram of a signal;

FIG. 4 is a diagram to illustrate a particular embodiment of a system that is operable to determine frequency domain gain shape parameters based on a harmonically extended signal and based on a high-band residual signal;

FIG. 5 is a diagram to illustrate a particular embodiment of a system that is operable to determine frequency domain gain shape parameters based on a high-band excitation signal and based on a high-band residual signal;

FIG. 6 is a diagram to illustrate a particular embodiment of a system that is operable to determine frequency domain gain shape parameters based on a synthesized high-band signal and based on a high-band signal;

FIG. 7 is a diagram to illustrate a particular embodiment of a system that is operable to reproduce an audio signal using frequency domain gain shape parameters;

FIG. 8 is flowchart to illustrate particular embodiments of methods of using frequency domain gain estimations for high-band reconstruction; and

FIG. 9 is a block diagram of a wireless device operable to perform signal processing operations in accordance with the systems and methods of FIGS. 1-8.

### VI. DETAILED DESCRIPTION

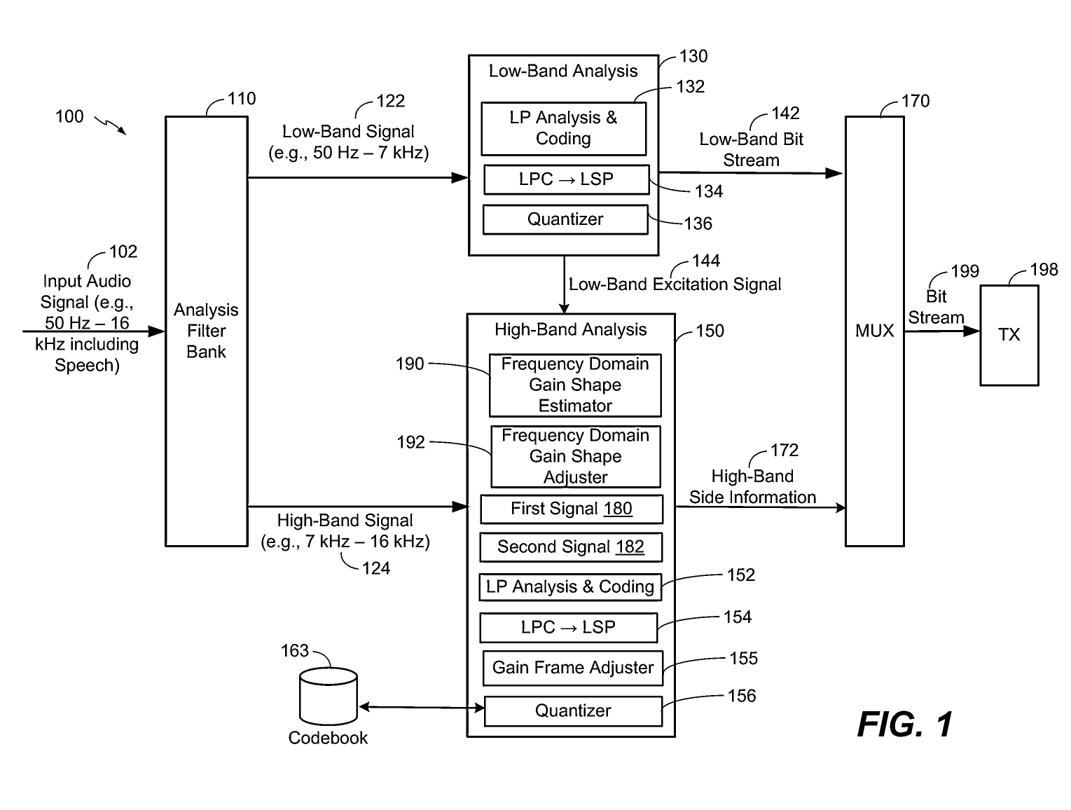

Referring to FIG. 1, a particular embodiment of a system that is operable to determine frequency domain gain shape parameters for high-band reconstruction is shown and generally designated 100. In a particular embodiment, the system 100 may be integrated into an encoding system or apparatus (e.g., in a wireless telephone or coder/decoder (CODEC)). In other embodiments, the system 100 may be integrated into a set top box, a music player, a video player, an entertainment unit, a navigation device, a communications device, a PDA, a fixed location data unit, or a computer.

It should be noted that in the following description, various functions performed by the system 100 of FIG. 1 are described as being performed by certain components or modules. However, this division of components and modules is for illustration only. In an alternate embodiment, a function performed by a particular component or module may instead be divided amongst multiple components or modules. Moreover, in an alternate embodiment, two or more components or modules of FIG. 1 may be integrated into a single component or module. Each component or module illustrated in FIG. 1 may be implemented using hardware (e.g., a field-programmable gate array (FPGA) device, an application-specific integrated circuit (ASIC), a digital signal processor (DSP), a controller, etc.), software (e.g., instructions executable by a processor), or any combination thereof.

The system 100 includes an analysis filter bank 110 that is configured to receive an input audio signal 102. For example, the input audio signal 102 may be provided by a microphone or other input device. In a particular embodiment, the input audio signal 102 may include speech. The input audio signal 102 may be a SWB signal that includes data in the frequency range from approximately 50 Hz to approximately 16 kHz. The analysis filter bank 110 may filter the input audio signal 102 into multiple portions based on frequency. For example, the analysis filter bank 110 may generate a low-band signal 122 and a high-band signal 124. The low-band signal 122 and the high-band signal 124 may have equal or unequal bandwidth, and may be overlapping or non-overlapping. In an alternate embodiment, the analysis filter bank 110 may generate more than two outputs.

In the example of FIG. 1, the low-band signal 122 and the high-band signal 124 occupy non-overlapping frequency bands. For example, the low-band signal 122 and the high-band signal 124 may occupy non-overlapping frequency bands of 50 Hz-7 kHz and 7 kHz-16 kHz, respectively. In an alternate embodiment, the low-band signal 122 and the high-band signal 124 may occupy non-overlapping frequency bands of 50 Hz-8 kHz and 8 kHz-16 kHz, respectively. In another alternate embodiment, the low-band signal 122 and the high-band signal 124 overlap (e.g., 50 Hz-8 kHz and 7 kHz-16 kHz, respectively), which may enable a low-pass filter and a high-pass filter of the analysis filter bank 110 to have a smooth rolloff, which may simplify design and reduce cost of the low-pass filter and the high-pass filter. Overlapping the low-band signal 122 and the high-band signal 124 may also enable smooth blending of low-band and high-band signals at a receiver, which may result in fewer audible artifacts.

It should be noted that although the example of FIG. 1 illustrates processing of a SWB signal, this is for illustration only. In an alternate embodiment, the input audio signal 102 may be a WB signal having a frequency range of approximately 50 Hz to approximately 8 kHz. In such an embodiment, the low-band signal 122 may correspond to a frequency range of approximately 50 Hz to approximately 6.4 kHz and the high-band signal 124 may correspond to a frequency range of approximately 6.4 kHz to approximately 8 kHz.

The system 100 may include a low-band analysis module 130 configured to receive the low-band signal 122. In a particular embodiment, the low-band analysis module 130 may represent an embodiment of a code excited linear prediction (CELP) encoder. The low-band analysis module 130 may include a linear prediction (LP) analysis and coding module 132, a linear prediction coefficient (LPC) to LSP transform module 134, and a quantizer 136. LSPs may also be referred to as LSFs, and the two terms (LSP and LSF) may be used interchangeably herein. The LP analysis and coding module 132 may encode a spectral envelope of the low-band signal 122 as a set of LPCs. LPCs may be generated for each frame of audio (e.g., 20 milliseconds (ms) of audio, corresponding to 320 samples at a sampling rate of 16 kHz), each sub-frame of audio (e.g., 5 ms of audio), or any combination thereof. The number of LPCs generated for each frame or sub-frame may be determined by the “order” of the LP analysis performed. In a particular embodiment, the LP analysis and coding module 132 may generate a set of eleven LPCs corresponding to a tenth-order LP analysis.

The LPC to LSP transform module 134 may transform the set of LPCs generated by the LP analysis and coding module 132 into a corresponding set of LSPs (e.g., using a one-to-one transform). Alternately, the set of LPCs may be one-to-one transformed into a corresponding set of parcor coefficients, log-area-ratio values, immittance spectral pairs (ISPs), or immittance spectral frequencies (ISFs). The transform between the set of LPCs and the set of LSPs may be reversible without error.

The quantizer 136 may quantize the set of LSPs generated by the LPC to LSP transform module 134. For example, the quantizer 136 may include or be coupled to multiple codebooks that include multiple entries (e.g., vectors). To quantize the set of LSPs, the quantizer 136 may identify entries of codebooks that are “closest to” (e.g., based on a distortion measure such as least squares or mean square error) the set of LSPs. The quantizer 136 may output an index value or series of index values corresponding to the location of the identified entries in the codebook. The output of the quantizer 136 thus represents low-band filter parameters that are included in a low-band bit stream 142.

The low-band analysis module 130 may also generate a low-band excitation signal 144. For example, the low-band excitation signal 144 may be an encoded signal that is generated by quantizing a LP residual signal that is generated during the LP process performed by the low-band analysis module 130. The LP residual signal may represent prediction error of the low-band excitation signal 144.

The system 100 may further include a high-band analysis module 150 configured to receive the high-band signal 124 from the analysis filter bank 110 and the low-band excitation signal 144 from the low-band analysis module 130. The high-band analysis module 150 may generate high-band side information 172 based on the high-band signal 124 and the low-band excitation signal 144. For example, the high-band side information 172 may include high-band LSPs and/or gain information (e.g., frequency domain gain shape parameters). In a particular embodiment, the gain information may include frequency domain gain shape parameters based on a first signal 180 and a second signal 182, as further described herein.

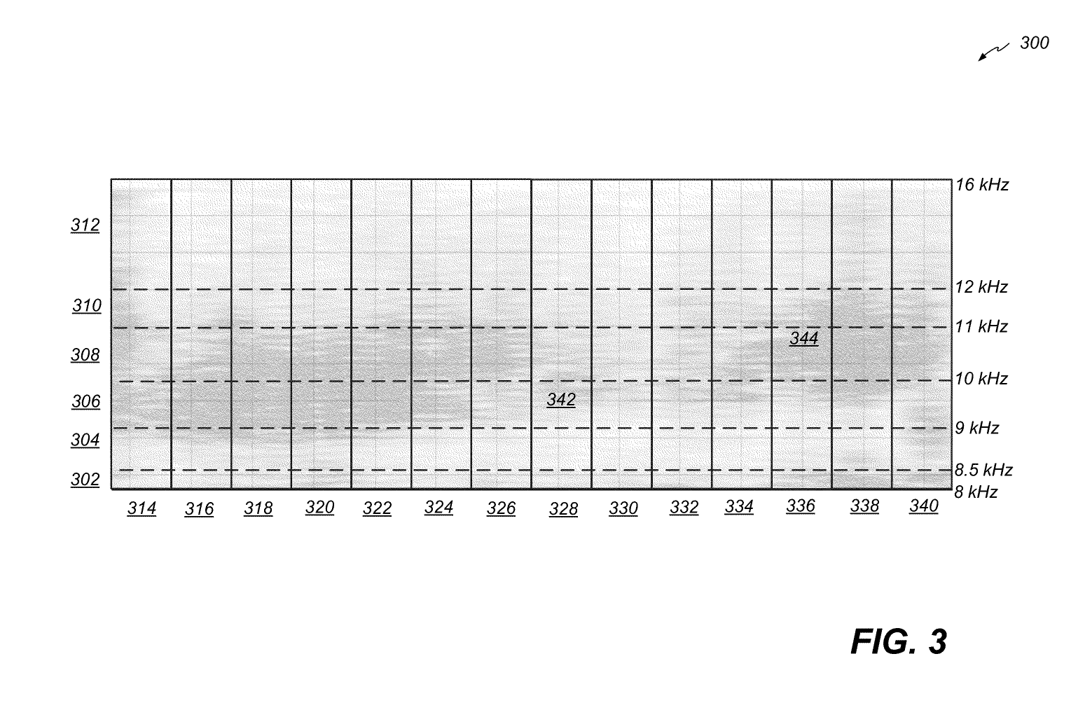

The high-band analysis module 150 may include a frequency domain gain shape estimator 190. The frequency domain gain shape estimator 190 may be configured to determine frequency domain gain shape parameters based on the first signal 180 and based on the second signal 182. For example, the first signal 180 may be a “target” signal and the second signal 182 may be a “reference” signal. The target signal may be sampled at a sampling rate to generate multiple target frames (or sub-frames) of sampled data, and the reference signal may be sampled at the sampling rate to generate multiple corresponding reference frames (or sub-frames) of sampled data. The frequency domain gain shape estimator 190 may also perform a transform operation (e.g., a FFT or a Discrete Cosine Transform (DCT)) on the first and second signals 180, 182 and partition the first and second signals 180, 182 into multiple sub-bands (e.g., multiple frequency bands). As explained in greater detail with respect to FIG. 3, each frame of the target signal may be divided into multiple sub-bands having equal or varying bandwidths, and each frame of the reference signal may be divided into corresponding sub-bands. As described herein, a particular sub-band of a particular frame (or sub-frame) may be referred to as a “tile.”

The frequency domain gain shape parameters may identify particular tiles of the first signal 180 having energy levels that do not approximate energy levels of corresponding tiles of the second signal 182. For example, the frequency domain gain shape estimator 190 may determine first energy levels for each tile (e.g., each sub-band in each frame) of the first signal 180 and determine second energy levels for corresponding tiles of the second signal 182. The frequency domain gain shape parameters may be based on ratios of the first energy levels and the second energy levels. For example, the frequency domain gain shape parameters may identify an energy scaling factor to apply to a first tile of the first signal 180 so that a resulting scaled energy level of the first tile approximates an energy level of a corresponding tile of the second signal 182.

The high-band analysis module 150 may also include a frequency domain gain shape adjuster 192. The frequency domain gain shape adjuster 192 may be configured to adjust the first signal 180 based on the frequency domain gain shape parameters. For example, the frequency domain gain shape adjuster 192 may “boost” the first tile of the first signal 180 to approximate an energy level of the corresponding tile of the second signal 182. Boosting the first tile of the first signal 180 may include amplifying a magnitude of the first tile of the first signal 180 so that the ratio of an energy level of the first tile of the first signal 180 to an energy level of the corresponding tile of the second signal 182 is approximately one. In another embodiment, the frequency domain gain shape adjuster 192 may attenuate the first tile of the first signal 180 to approximate an energy level of the corresponding tile of the second signal 182. The tile-based gain shape adjustment enables reliable mimicking of the time-frequency evolution of the second signal 182. The tile-based gain shape adjustment may also enable dynamic selection of a quantity of sub-frames and a quantity of sub-bands for tile generation. As described below, the time-frequency resolution of a tile may be based on the input signal characteristics.

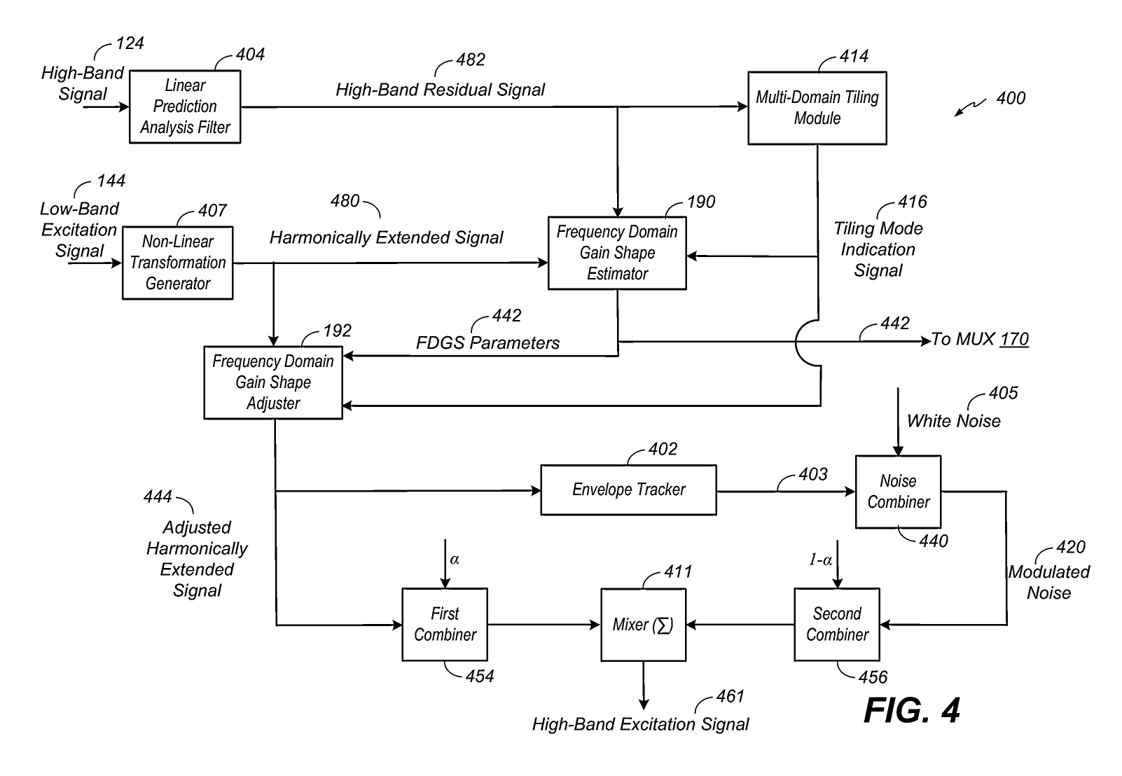

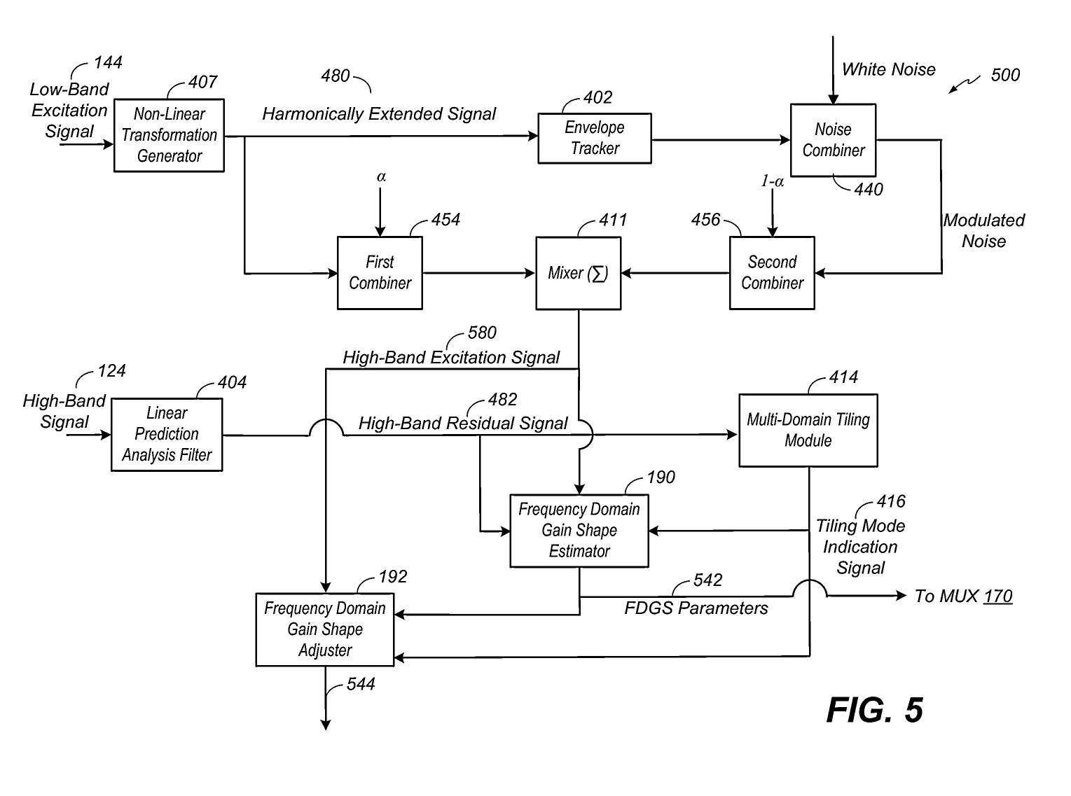

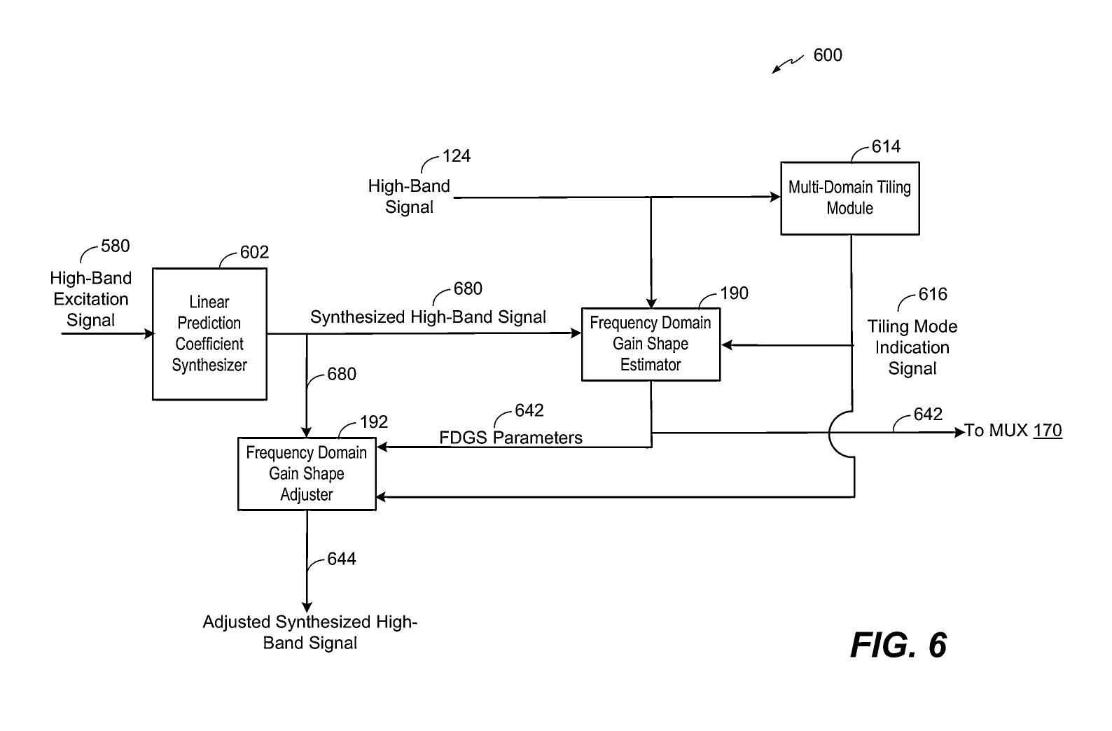

As described herein, the first signal 180 may be a modeled high-band excitation from the low-band excitation signal 144, and the second signal 182 may be a high-band residual of the high-band signal 124, such as described with respect to FIG. 5. In other embodiments, the first signal 180 may be a transformed (e.g., non-linear) low-band excitation of the low-band signal 122, and the second signal 182 may be the high-band residual of the high-band signal 124, such as described with respect to FIG. 4. In yet other embodiments, the first signal 180 may be a synthesized version of the high-band signal 124, and the second signal 182 may be the high-band signal 124, such as described with respect to FIG. 6. In addition, the system 100 may be operable to generate frequency domain gain shape parameters at multiple stages. For example, first frequency domain gain shape parameters may be generated based on the high-band excitation of the high-band signal 124 and based on the high-band residual of the high-band signal 124, second frequency domain gain shape parameters may be generated based on the harmonically extended version of a low-band excitation of the low-band signal 122 and based on the high-band residual of the high-band signal 124, third frequency domain gain shape parameters may be generated based on the synthesized version of the high-band signal 124 and based on the high-band signal 124, or any combination thereof. The synthesized version of the high-band signal 124 may correspond to a reproduced version of the high-band signal 124 generated from the low-band excitation signal 144 and from characteristics of the high-band signal 124.

As illustrated, the high-band analysis module 150 may also include an LP analysis and coding module 152, a LPC to LSP transform module 154, a gain frame adjuster 155, and a quantizer 156. Each of the LP analysis and coding module 152, the LPC to LSP transform module 154, and the quantizer 156 may function as described above with reference to corresponding components of the low-band analysis module 130, but at a comparatively reduced resolution (e.g., using fewer bits for each coefficient, LSP, etc.). The LP analysis and coding module 152 may generate a set of LPCs that are transformed to LSPs by the transform module 154 and quantized by the quantizer 156 based on a codebook 163. For example, the LP analysis and coding module 152, the LPC to LSP transform module 154, and the quantizer 156 may use the high-band signal 124 to determine high-band filter information (e.g., high-band LSPs) that is included in the high-band side information 172. The gain frame adjuster 155 may be configured to adjust an overall gain of a frame on a frame-by-frame basis based on gain frame parameters. The gain frame parameters may be based on a high-band excitation signal, as described in greater detail with respect to FIG. 5.

The quantizer 156 may be configured to quantize a set of spectral frequency values, such as LSPs provided by the transform module 154. In other embodiments, the quantizer 156 may receive and quantize sets of one or more other types of spectral frequency values in addition to, or instead of, LSFs or LSPs. For example, the quantizer 156 may receive and quantize a set of LPCs generated by the LP analysis and coding module 152. Other examples include sets of parcor coefficients, log-area-ratio values, and ISFs that may be received and quantized at the quantizer 156. The quantizer 156 may include a vector quantizer that encodes an input vector (e.g., a set of spectral frequency values in a vector format) as an index to a corresponding entry in a table or codebook, such as the codebook 163. As another example, the quantizer 156 may be configured to determine one or more parameters from which the input vector may be generated dynamically at a decoder, such as in a sparse codebook embodiment, rather than retrieved from storage. To illustrate, sparse codebook examples may be applied in coding schemes such as CELP and codecs according to industry standards such as 3 GPP2 (Third Generation Partnership 2) EVRC (Enhanced Variable Rate Codec). In another embodiment, the high-band analysis module 150 may include the quantizer 156 and may be configured to use a number of codebook vectors to generate synthesized signals (e.g., according to a set of filter parameters) and to select one of the codebook vectors associated with the synthesized signal that best matches the high-band signal 124, such as in a perceptually weighted domain.

In a particular embodiment, the high-band side information 172 may include high-band LSPs as well as high-band gain parameters. For example, the high-band side information 172 may include the frequency domain gain shape parameters generated by the frequency domain gain shape estimator 190.

The low-band bit stream 142 and the high-band side information 172 may be multiplexed by a multiplexer (MUX) 170 to generate an output bit stream 199. The output bit stream 199 may represent an encoded audio signal corresponding to the input audio signal 102. For example, the multiplexer 170 may be configured to insert the frequency domain gain shape parameters included in the high-band side information 172 into an encoded version of the input audio signal 102 to enable gain adjustment during reproduction of the input audio signal 102. The output bit stream 199 may be transmitted (e.g., over a wired, wireless, or optical channel) by a transmitter 198 and/or stored. At a receiver, reverse operations may be performed by a demultiplexer (DEMUX), a low-band decoder, a high-band decoder, and a filter bank to generate an audio signal (e.g., a reconstructed version of the input audio signal 102 that is provided to a speaker or other output device). The number of bits used to represent the low-band bit stream 142 may be substantially larger than the number of bits used to represent the high-band side information 172. Thus, most of the bits in the output bit stream 199 may represent low-band data. The high-band side information 172 may be used at a receiver to regenerate the high-band excitation signal from the low-band data in accordance with a signal model. For example, the signal model may represent an expected set of relationships or correlations between low-band data (e.g., the low-band signal 122) and high-band data (e.g., the high-band signal 124). Thus, different signal models may be used for different kinds of audio data (e.g., speech, music, etc.), and the particular signal model that is in use may be negotiated by a transmitter and a receiver (or defined by an industry standard) prior to communication of encoded audio data. Using the signal model, the high-band analysis module 150 at a transmitter may be able to generate the high-band side information 172 such that a corresponding high-band analysis module at a receiver is able to use the signal model to reconstruct the high-band signal 124 from the output bit stream 199.

The system 100 of FIG. 1 may improve energy correlation between the first signal 180 and the second signal 182. For example, during frequency domain gain shaping, energy levels of sub-bands of the first signal 180 may be adjusted to approximate energy levels of corresponding sub-bands of the second signal 182 based on frequency domain gain shape parameters. Adjusting the first signal 180 may improve gain shape estimation and reduce audible artifacts during high-band reconstruction of the input audio signal 102. The frequency domain gain shape parameters may be transmitted to a decoder to reduce audible artifacts during high-band reconstruction of the input audio signal 102.

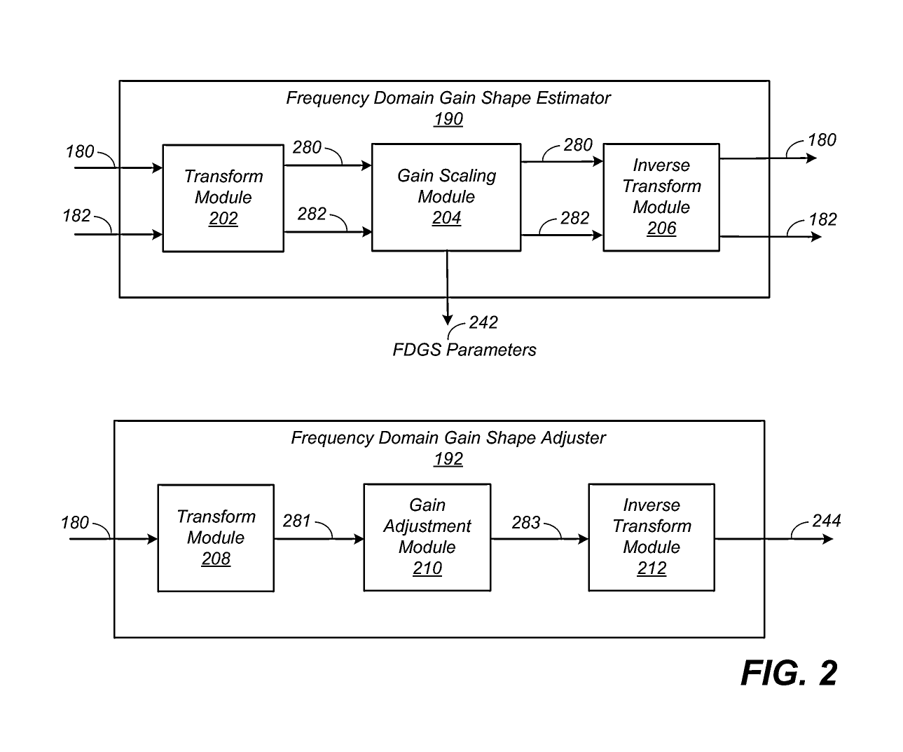

Referring to FIG. 2, particular embodiments of the frequency domain gain shape estimator 190 and the frequency domain gain shape adjuster 192 are shown. The frequency domain gain shape estimator 190 may include a first transform module 202, a gain scaling module 204, and a first inverse transform module 206. Although the frequency domain gain shape estimator 190 depicts the first inverse transform module 206 in FIG. 2, in alternate embodiments, the first inverse transform module 206 may be absent from the frequency domain gain shape estimator 190. The frequency domain gain shape adjuster 192 may include a second transform module 208, a gain adjustment module 210, and a second inverse transform module 212.

The first transform module 202 may be configured to convert the first signal 180 of FIG. 1 and the second signal 182 of FIG. 1 from a time-domain into a frequency domain (e.g., transform domain). For example, the first transform module 202 may perform a FFT operation, a DCT operation, a Discrete Fourier Transform (DFT) operation, or a Modified Discrete Cosine Transform (MDCT) operation on the first and second signals 180, 182 to convert the first and second signals 180, 182 into first and second transformed signals 280, 282, respectively. For example, the first transform module 202 may calculate transform coefficients that correspond to different frequency bands of the first and second signals 180, 182.

As described with respect to FIG. 3, the frequency bands may be uniform in size or non-uniform in size. Referring to FIG. 3, an illustrative embodiment of a spectrogram 300 of a signal is shown. The spectrogram 300 may correspond to a frame (or sub-frame) of the first transformed signal 280 or a corresponding frame (or sub-frame) of the second transformed signal 282.

Vertical lines (e.g., solid lines) may partition the signal illustrated in the spectrogram 300 into multiple frames (or sub-frames), and horizontal lines (e.g., dashed lines) may partition the signal into multiple sub-bands. For example, the spectrogram 300 may include six sub-bands 302-312 and fourteen frames 314-340. In a particular embodiment, the six sub-bands 302-312 may range from 8 kHz to 16 kHz and each frame 314-340 may be approximately 20 ms. Although six sub-bands 302-312 and fourteen frames 314-340 are illustrated, the number of sub-bands and the number of frames may be adjusted based on a tiling mode indication signal, as described with respect to FIGS. 4-6. A bandwidth of the sub-bands 302-312 may also be adjustable based on the tiling mode indication signal.

In a particular embodiment, a bandwidth of a particular sub-band illustrated in the spectrogram 300 may be different than a bandwidth of another sub-band (e.g., non-uniform bandwidths). For example, the sixth sub-band 312 corresponding to relatively high frequency levels (e.g., approximately 12 kHz-16 kHz) may have a larger bandwidth than the first sub-band 302 corresponding to relatively low frequency levels (e.g., approximately 8 kHz-8.5 kHz). Lower frequency levels may include sub-bands having “finer” (e.g., narrower) bandwidths to enable more frequency gain shape parameters (e.g., finer tuning) for frequencies more easily discerned within the human auditory system. In other embodiments, the bandwidths of each sub-band 302-312 may be uniform. A particular sub-band of a particular frame (or sub-frame) may correspond to a “tile.” For example, a first tile 342 may correspond to the third sub-band 306 of the eighth frame 328, and a second tile 344 may correspond to the fourth sub-band 308 of the twelfth frame 336.

Referring back to FIG. 2, the transformed signals 280, 282 may be provided to the gain scaling module 204. The gain scaling module 204 may be configured to determine frequency domain gain shape parameters 242 based on the transformed signals 280, 282. For example, the gain scaling module 204 may determine first energy levels of each tile in the first transformed signal 280 and corresponding second energy levels of corresponding tiles in the second transformed signal 282. The energy level of each tile may be expressed using two FFT coefficients (or other transform coefficients). For example, energy matching for thirty-two tiles (e.g., four frequency bands and eight sub-frames or sixteen frequency bands and two sub-frames) may be expressed and transmitted as frequency domain gain shape (FDGS) parameters 242 using sixty-four FFT coefficients. The frequency domain gain shape parameters 242 may be based on a ratio of the first energy levels and the second energy levels. In a particular embodiment, 64 tiles may be represented using 128 FFT coefficients. The gain scaling module 204 may provide the frequency domain gain shape parameters 242 to the gain adjustment module 210 of the frequency domain gain shape adjuster 192.

The first inverse transform module 206 may be configured to convert the first transformed signal 280 and the second transformed signal 282 from the frequency domain back to the time-domain. For example, the first inverse transform module 206 may perform an Inverse Fast Fourier Transform (IFFT) or an Inverse Discrete Cosine Transform (IDCT) operation on the first and second transformed signals 280, 282 to convert the first and second transformed signals 280, 282 back into first and second signals 180, 182, respectively.

The second transform module 208 may operate in a substantially similar manner as the first transform module 202. For example, the second transform module 208 may be configured to convert the first signal 180 from the time-domain into the frequency domain to generate a first transformed signal 281. The first transformed signal 281 may be substantially similar to the first transformed signal 280. The gain adjustment module 210 may be configured to adjust the first transformed signal 281 based on the frequency domain gain shape parameters 242 to generate a first adjusted transformed signal 283. For example, the gain adjustment module 210 may adjust the first transformed signal 281 so that an energy level of a particular tile of the first transformed signal 281 is approximately equal to an energy level of a corresponding tile of the second transformed signal 282.

The second inverse transform module 212 may operate in a substantially similar manner as the first inverse transform module 206. For example, the second inverse transform module 212 may be configured to convert the first adjusted transformed signal 283 from the frequency domain to the time-domain to generate a frequency-domain-adjusted signal 244.

Using the transform modules 202, 208 to convert the first and second signal 180, 182 from the time-domain to the frequency domain enables target frequency gain shape scaling instead of, or in addition to, time-domain gain shape scaling. For example, energy levels of sub-bands may be approximated and adjusted to model the first signal 180 based on the second signal 182. In addition, bandwidths of sub-bands may be non-uniform in size to enable concentrated gain shaping at particular frequency levels (e.g., frequency levels more easily discerned within the human auditory system).

In other embodiments, the frequency domain gain shape estimator 190 may receive frequency domain signals and may determine frequency domain gain shape parameters 242 without having to convert signals into the frequency domain. Thus, in other embodiments, the frequency domain gain shape estimator 190 may not include the first transform module 202 or the first inverse transform module 206. In a similar manner, other embodiments of the frequency domain gain shape adjuster 192 may not include the second transform module 208 or the second inverse transform module 212.

Referring to FIG. 4, a particular embodiment of a system 400 that is operable to determine frequency domain gain shape parameters based on a harmonically extended signal and based on a high-band residual signal is shown. The system 400 includes a linear prediction analysis filter 404, a non-linear transformation generator 407, a multi-domain tiling module 414, the frequency domain gain shape estimator 190, and the frequency domain gain shape adjuster 192.

The low-band excitation signal 144 may be provided to the non-linear transformation generator 407. As described with respect to FIG. 1, the low-band excitation signal 144 may be generated from the low-band signal 122 (e.g., the low-band portion of the input audio signal 102) using the low-band analysis module 130. The non-linear transformation generator 407 may be configured to generate a harmonically extended signal 480 based on the low-band excitation signal 144. For example, the non-linear transformation generator 407 may perform an absolute-value operation or a square operation on frames (or sub-frames) of the low-band excitation signal 144 to generate the harmonically extended signal 480.

To illustrate, the non-linear transformation generator 407 may up-sample the low-band excitation signal 144 (e.g., an 8 kHz signal ranging from approximately 0 kHz to 8 kHz) to generate a 16 kHz signal ranging from approximately 0 kHz to 16 kHz (e.g., a signal having approximately twice the bandwidth of the low-band excitation signal 144). A low-band portion of the 16 kHz signal (e.g., approximately from 0 kHz to 8 kHz) may have substantially similar harmonics as the low-band excitation signal 144, and a high-band portion of the 16 kHz signal (e.g., approximately from 8 kHz to 16 kHz) may be substantially free of harmonics. The non-linear transformation generator 407 may extend the “dominant” harmonics in the low-band portion of the 16 kHz signal to the high-band portion of the 16 kHz signal to generate the harmonically extended signal 480. Thus, the harmonically extended signal 408 may be a harmonically extended version of the low-band excitation signal 144 that extends into the high-band using non-linear operations (e.g., square operations and/or absolute value operations). The harmonically extended signal 480 may be provided to the frequency domain gain shape estimator 190 and to the frequency domain gain shape adjuster 192. The harmonically extended signal 480 may correspond to the first signal 180 (e.g., the target signal) of FIG. 1.

The high-band signal 124 may be provided to the linear prediction analysis filter 404. The linear prediction analysis filter 404 may be configured to generate a high-band residual signal 482 based on the high-band signal 124 (e.g., a high-band portion of the input audio signal 102). For example, the linear prediction analysis filter 404 may encode a spectral envelope of the high-band signal 124 as a set of the LPCs used to predict future samples of the high-band signal 124. The high-band residual signal 482 may be provided to the multi-domain tiling module 414 and to the frequency domain gain shape estimator 190. The high-band residual signal 482 may correspond to the second signal 182 (e.g., the reference signal) of FIG. 1.

The multi-domain tiling module 414 may be configured to determine a tiling mode (e.g., select a time-frequency tiling based on characteristics of the high-band residual signal 482) for the high-band residual signal 482 and for the harmonically extended signal 480 during frequency gain shape estimation. The tiling mode may include data representing sampling rates and sub-band parameters for the reference signal and the target signal. The multi-domain tiling module 414 may be configured to determine sampling rates and sub-band parameters based on characteristics of the high-band residual signal 482 (e.g., characteristics of the input audio signal 102 of FIG. 1).

For example, the multi-domain tiling module 414 may generate a tiling mode indication signal 416 that corresponds to a higher time-resolution (e.g., a relatively high sampling rate yielding a larger number of samples per frame) and a lower frequency resolution (e.g., a relatively smaller number of sub-bands) in response to a determination that the high-band residual signal 482 corresponds to a time-localized transient sound. Alternatively, the multi-domain tiling module 414 may generate a tiling mode indication signal 416 that corresponds to a lower time-resolution (e.g., a relatively low sampling rate yielding a smaller number of samples per frame) and a higher frequency resolution (e.g., a relatively larger number of sub-bands) in response to a determination that the high-band residual signal 482 corresponds to a stationary sound (e.g., a sound that does not include quick transitions) that may include fluctuating harmonics.

The frequency domain gain shape estimator 190 may receive the tiling mode indication signal 416, the harmonically extended signal 480, and the high-band residual signal 482. The frequency domain gain shape estimator 190 may be configured to perform a transform operation based on the tiling mode indication signal 416. For example, the frequency domain gain shape estimator 190 may select the sampling rate and sub-band parameters based on the tiling mode indication signal 416. For example, the tiling mode indication signal 416 may indicate the sampling rate and the sub-band parameters. The frequency domain gain shape estimator 190 may determine frequency domain gain shape parameters 442 based on the harmonically extended signal 480 (e.g., the first signal 180) and based on the high-band residual signal 482 (e.g., the second signal 182) in a similar manner as described with respect to FIG. 2. In a particular embodiment, components of the frequency domain gain shape estimator 190 (e.g., the transform module 202, the gain scaling module 204, etc.) may be implemented separately in the system 400. For example, the transform module 202 and the gain scaling module 204 do not necessarily have to be implemented within the frequency domain gain shape estimator 190. The transform module 202 may be implemented within a separate processing unit and the gain scaling module 204 may be implemented within a separate processing unit.

For example, the frequency domain gain shape estimator 190 may evaluate energy levels of each tile of the harmonically extended signal 480 and evaluate energy levels of each corresponding tile of the high-band residual signal 482. The frequency domain gain shape parameters 442 may identify particular tiles of the harmonically extended signal 480 that have lower energy levels than corresponding tiles of the high-band residual signal 482. The frequency domain gain shape estimator 190 may also determine an amount of “boost” energy to provide to each tile of the harmonically extended signal 480 so that an energy level of each tile of the harmonically extended signal 480 approximates an energy level of each corresponding tile of the high-band residual signal 482. The frequency domain gain shape parameters 442 may identify each tile of the harmonically extended signal 480 that requires an energy boost and may identify the calculated energy boost for the respective tiles. The energy boost may be expressed as one or more multiplication gain factors to increase or decrease one or more signal values of the harmonically extended signal 480. The frequency domain gain shape parameters 442 may correspond to the frequency domain gain shape parameters 242 of FIG. 2. The frequency domain gain shape parameters 442 may be provided to the frequency domain gain shape adjuster 192 and to the multiplexer 170 of FIG. 1 as high-band side information 172.

The frequency domain gain shape adjuster 192 may receive the tiling mode indication signal 416, the harmonically extended signal 480, and the frequency domain gain shape parameters 442. The frequency domain gain shape adjuster 192 may be configured to adjust the harmonically extended signal 480 based on the frequency domain gain shape parameters 442 to generate an adjusted harmonically extended signal 444 (e.g., the frequency-domain-adjusted signal 244) in a similar manner as described with respect to FIG. 2. For example, the frequency domain gain shape adjuster 192 may boost the identified tiles of the harmonically extended signal 480 according to the calculated energy boost to generate the adjusted harmonically extended signal 444. In a particular embodiment, the frequency domain gain shape adjuster 192 may attenuate the first tile of the harmonically extended signal 480 to approximate an energy level of the corresponding tile of the high-band residual signal 482. The tile-based gain shape adjustment enables reliable mimicking of the time-frequency evolution of the high-band residual signal. The tile-based gain shape adjustment may also enable dynamic selection of a quantity of sub-frames and a quantity of sub-bands for tile generation. The adjusted harmonically extended signal 444 may be provided to an envelope tracker 402 and to a first combiner 454. In a particular embodiment, components of the frequency domain gain shape adjuster 192 (e.g., the transform module 208, gain adjustment module 210, the inverse transform module 212, etc.) may be implemented separately in the system 400. For example, the transform module 208, gain adjustment module 210, and the inverse transform module 212 do not necessarily have to be implemented within the frequency domain gain shape adjuster 192. The transform module 208 may be implemented within a separate processing unit, the gain adjustment module 210 may be implemented within a separate processing unit, and the inverse transform module 212 may be implemented within a separate processing unit.

The envelope tracker 402 may be configured to receive the adjusted harmonically extended signal 444 and to calculate a low-band time-domain envelope 403 corresponding to the adjusted harmonically extended signal 444. For example, the envelope tracker 402 may be configured to calculate the square of each sample of a frame of the adjusted harmonically extended signal 444 to produce a sequence of squared values. The envelope tracker 402 may be configured to perform a smoothing operation on the sequence of squared values, such as by applying a first order infinite impulse response (IIR) low-pass filter to the sequence of squared values. The envelope tracker 402 may be configured to apply a square root function to each sample of the smoothed sequence to produce the low-band time-domain envelope 403. The low-band time-domain envelope 403 may be provided to a noise combiner 440.

The noise combiner 440 may be configured to combine the low-band time-domain envelope 403 with white noise 405 generated by a white noise generator (not shown) to produce a modulated noise signal 420. For example, the noise combiner 440 may be configured to amplitude-modulate the white noise 405 according to the low-band time-domain envelope 403. In a particular embodiment, the noise combiner 440 may be implemented as a multiplier that is configured to scale the white noise 405 according to the low-band time-domain envelope 403 to produce the modulated noise signal 420. The modulated noise signal 420 may be provided to a second combiner 456.

A first combiner 454 may be implemented as a multiplier that is configured to scale the adjusted harmonically extended signal 444 according to a mixing factor (a) to generate a first scaled signal. A second combiner 456 may be implemented as a multiplier that is configured to scale the modulated noise signal 420 based on the mixing factor (α) to generate a second scaled signal. For example, the second combiner 456 may scale the modulated noise signal 420 based on the difference of one minus the mixing factor (e.g., 1−α) to generate the second scaled signal. The first scaled signal and the second scaled signal may be provided to a mixer 411.

The mixer 411 may generate a high-band excitation signal 461 based on the mixing factor (α), the adjusted harmonically extended signal 444, and the modulated noise signal 420. For example, the mixer 411 may combine the first scaled signal and the second scaled signal to generate the high-band excitation signal 461.

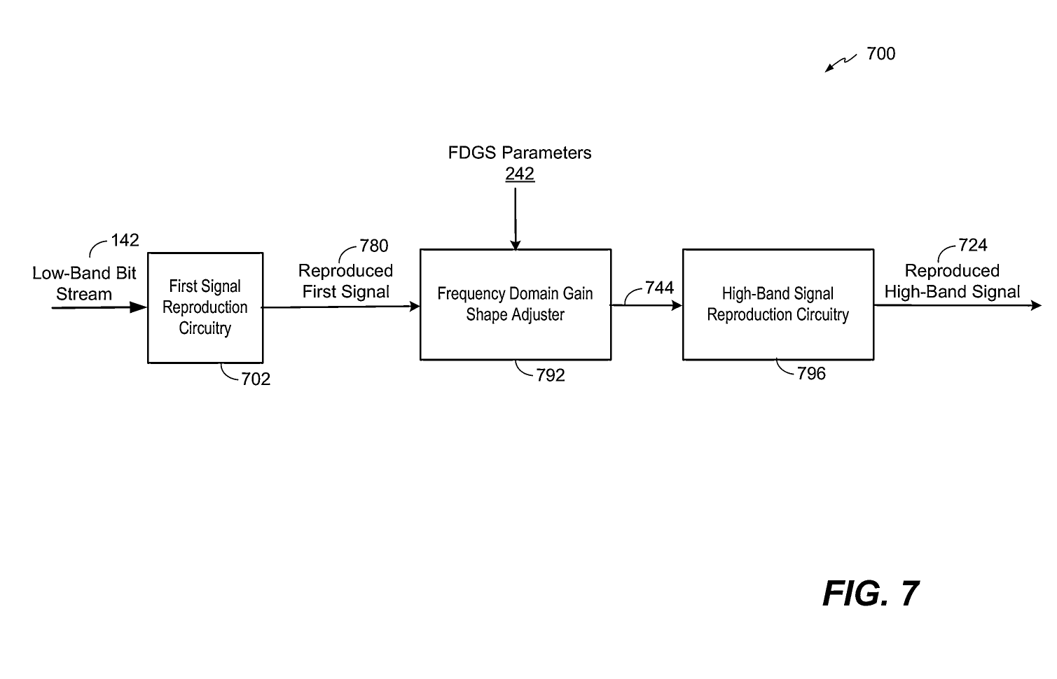

The system 400 of FIG. 4 may improve high-band reconstruction of the input audio signal 102 of FIG. 1 by generating frequency domain gain shape parameters 442 based on energy levels of tiles of the harmonically extended signal 480 and corresponding energy levels of corresponding tiles of the high-band residual signal 482. The frequency domain gain shape parameters 442 may reduce audible artifacts during high-band reconstruction of the input audio signal 102 at a receiver device, such as described in further detail with respect to FIG. 7.

Referring to FIG. 5, a particular illustrative embodiment of a system 500 that is operable to determine frequency domain gain shape parameters based on a high-band excitation signal and based on a high-band residual signal is shown. The system 500 may include components described with respect to FIG. 4, such as the non-linear transformation generator 407, the envelope tracker 402, the noise combiner 440, the first combiner 454, the second combiner 456, and the mixer 411. The components described with respect to FIG. 4 may generate a high-band excitation signal 580 based on the harmonically extended signal 480 as opposed to generating the high-band excitation signal 461 based on the adjusted harmonically extended signal 444. The high-band excitation signal 580 may correspond to the first signal 180 (e.g., the target signal) of FIG. 1.

The system 500 may also include the linear prediction analysis filter 404 of FIG. 4. The high-band signal 124 may be provided to the linear prediction analysis filter 404, and the linear prediction analysis filter 404 may be configured to generate the high-band residual signal 482 based on the high-band signal 124. The high-band residual signal 482 may correspond to the second signal 182 (e.g., the reference signal) of FIG. 1.

The multi-domain tiling module 414 may be configured to determine a tiling mode (e.g., a time-frequency tiling) for the high-band residual signal 482 and the high-band excitation signal 580 during frequency gain shape estimation. The multi-domain tiling module 414 may generate a tiling mode indication signal 416 that corresponds to a higher time-resolution (e.g., a relatively high sampling rate yielding a larger number of samples per frame) and a lower frequency resolution (e.g., a relatively smaller number of sub-bands) in response to a determination that the high-band residual signal 482 corresponds to a time-localized transient sound. Alternatively, the multi-domain tiling module 414 may generate a tiling mode indication signal 416 that corresponds to a lower time-resolution (e.g., a relatively low sampling rate yielding a smaller number of samples per frame) and a higher frequency resolution (e.g., a relatively larger number of sub-bands) in response to a determination that the high-band residual signal 482 corresponds to a stationary sound (e.g., a sound that does not include quick transitions) that may include fluctuating harmonics (e.g., human speech).

The frequency domain gain shape estimator 190 may receive the tiling mode indication signal 416, the high-band excitation signal 580, and the high-band residual signal 482. The frequency domain gain shape estimator 190 may determine frequency domain gain shape parameters 542 based on the high-band excitation signal 580 and based on the high-band residual signal 482 in a similar manner as described with respect to FIG. 2. In a particular embodiment, the frequency domain gain shape parameters 542 may be the frequency domain gain shape parameters 242 of FIG. 2. The frequency domain gain shape parameters 542 may be provided to the frequency domain gain shape adjuster 192 and to the multiplexer 170 of FIG. 1 as high-band side information 172. In a particular embodiment, components of the frequency domain gain shape estimator 190 (e.g., the transform module 202, the gain scaling module 204, etc.) may be implemented separately in the system 500. For example, the transform module 202 and the gain scaling module 204 do not necessarily have to be implemented within the frequency domain gain shape estimator 190. The transform module 202 may be implemented within a separate processing unit and the gain scaling module 204 may be implemented within a separate processing unit.

The frequency domain gain shape adjuster 192 may receive the tiling mode indication signal 416, the high-band excitation signal 580, and the frequency domain gain shape parameters 542. The frequency domain gain shape adjuster 192 may be configured to adjust the high-band excitation signal 580 based on the frequency domain gain shape parameters 542 to generate an adjusted high-band excitation signal 544 (e.g., the frequency-domain-adjusted signal 244) in a similar manner as described with respect to FIG. 2. For example, the frequency domain gain shape adjuster 192 may attenuate the first tile of the high-band excitation signal 580 to approximate an energy level of the corresponding tile of the high-band residual signal 482. The adjusted high-band excitation signal 544 may be used to generate gain frame parameters. The gain frame parameters may be used by a gain frame adjuster (e.g., the gain frame adjuster 155 of FIG. 1) to adjust the gain of each frame on a frame-by-frame basis. The tile-based gain shape adjustment enables reliable mimicking of the time-frequency evolution of the high-band residual signal 482. The tile-based gain shape adjustment may also enable dynamic selection of a quantity of sub-frames and a quantity of sub-bands for tile generation. In a particular embodiment, components of the frequency domain gain shape adjuster 192 (e.g., the transform module 208, gain adjustment module 210, the inverse transform module 212, etc.) may be implemented separately in the system 500. For example, the transform module 208, gain adjustment module 210, and the inverse transform module 212 do not necessarily have to be implemented within the frequency domain gain shape adjuster 192. The transform module 208 may be implemented within a separate processing unit, the gain adjustment module 210 may be implemented within a separate processing unit, and the inverse transform module 212 may be implemented within a separate processing unit.

The system 500 of FIG. 5 may improve high-band reconstruction of the input audio signal 102 of FIG. 1 by generating frequency domain gain shape parameters 542 based on energy levels of tiles of the high-band excitation signal 580 and corresponding energy levels of corresponding tiles of the high-band residual signal 482. The frequency domain gain shape parameters 542 may reduce audible artifacts during high-band reconstruction of the input audio signal 102.

Referring to FIG. 6, a particular illustrative embodiment of a system 600 that is operable to determine frequency domain gain shape parameters based on a synthesized high-band signal and based on a high-band signal is shown. The system 600 includes the frequency domain gain shape estimator 190, the frequency domain gain shape adjuster 192, a linear prediction coefficient synthesizer 602, and a multi-domain tiling module 614.

The linear prediction coefficient synthesizer 602 may be configured to receive the high-band excitation signal 580 and to perform a linear prediction coefficient synthesis operation on the high-band excitation signal 580 to generate a synthesized high-band signal 680. The synthesized high-band signal 680 may be provided to the frequency domain gain shape estimator 190 and to the frequency domain gain shape adjuster 192. With reference to FIG. 6, the synthesized high-band signal 680 may correspond to the first signal 180 (e.g., the target signal) of FIG. 1.

The high-band signal 124 of FIG. 1 may be provided to the frequency domain gain shape estimator 190 and to the multi-domain tiling module 614. In the system 600, the high-band signal 124 may correspond to the second signal 182 (e.g., the reference signal) of FIG. 1. During frequency gain shape estimation, the multi-domain tiling module 614 may operate in a substantially similar manner with respect to the high-band signal 124 as the multi-domain tiling module 414 of FIG. 4 operates with respect to the high-band residual signal 482. For example, the multi-domain tiling module 614 may generate a tiling mode indication signal 616 in a substantially similar manner as described with respect to FIG. 4.

The frequency domain gain shape estimator 190 may receive the tiling mode indication signal 616, the synthesized high-band signal 680, and the high-band signal 124. The frequency domain gain shape estimator 190 may determine frequency domain gain shape parameters 642 based on the synthesized high-band signal 680 and based on the high-band signal 124 in a similar manner as described with respect to FIG. 2. The frequency domain gain shape parameters 642 may correspond to the frequency domain gain shape parameters 242 of FIG. 2. The frequency domain gain shape parameters 642 may be provided to the frequency domain gain shape adjuster 192 and to the multiplexer 170 of FIG. 1 as high-band side information 172. In a particular embodiment, components of the frequency domain gain shape estimator 190 (e.g., the transform module 202, the gain scaling module 204, etc.) may be implemented separately in the system 600. For example, the transform module 202 and the gain scaling module 204 do not necessarily have to be implemented within the frequency domain gain shape estimator 190. The transform module 202 may be implemented within a separate processing unit and the gain scaling module 204 may be implemented within a separate processing unit.

The frequency domain gain shape adjuster 192 may receive the tiling mode indication signal 616, the synthesized high-band signal 680, and the frequency domain gain shape parameters 642. The frequency domain gain shape adjuster 192 may be configured to adjust the synthesized high-band signal 680 based on the frequency domain gain shape parameters 642 to generate an adjusted synthesized high-band signal 644 (e.g., the frequency-domain-adjusted signal 244) in a similar manner as described with respect to FIG. 2. For example, the frequency domain gain shape adjuster 192 may attenuate the first tile of the synthesized high-band signal 680 to approximate an energy level of the corresponding tile of the high-band signal 124. The tile-based gain shape adjustment enables reliable mimicking of the time-frequency evolution of the high-band signal 124. The tile-based gain shape adjustment may also enable dynamic selection of a quantity of sub-frames and a quantity of sub-bands for tile generation. In a particular embodiment, components of the frequency domain gain shape adjuster 192 (e.g., the transform module 208, gain adjustment module 210, the inverse transform module 212, etc.) may be implemented separately in the system 600. For example, the transform module 208, gain adjustment module 210, and the inverse transform module 212 do not necessarily have to be implemented within the frequency domain gain shape adjuster 192. The transform module 208 may be implemented within a separate processing unit, the gain adjustment module 210 may be implemented within a separate processing unit, and the inverse transform module 212 may be implemented within a separate processing unit.

The system 600 of FIG. 6 may improve high-band reconstruction of the input audio signal 102 of FIG. 1 by generating frequency domain gain shape parameters 642 based on energy levels of tiles of the synthesized high-band signal 680 and corresponding energy levels of corresponding tiles of the high-band signal 124. The frequency domain gain shape parameters 642 may reduce audible artifacts during high-band reconstruction of the input audio signal 102.

Although the systems 400-600 of FIGS. 4-6 illustrate a multi-domain (e.g., a frequency domain and time domain) tiling module 414, 614, other embodiments may determine frequency gain shape parameters without using a multi-domain tiling module. For example, other embodiments may use a uniform sampling rate and a uniform number of sub-bands to determine frequency domain gain shape parameters for each frame. Generating frequency domain gain shape parameters using the multi-domain tiling module 414, 614 may generate enhanced gain estimates based on characteristics of the audio signal. Generating frequency domain gain shape parameters without the multi-domain tiling module 414, 614 may reduce cost and complexity.

Referring to FIG. 7, a particular embodiment of a system 700 that is operable to reproduce an audio signal using frequency domain gain shape parameters is shown. The system 700 includes first signal reproduction circuitry 702 and a frequency domain gain shape adjuster 792. In a particular embodiment, the system 700 may be integrated into a decoding system or apparatus (e.g., in a wireless telephone or CODEC). In other particular embodiments, the system 700 may be integrated into a set top box, a music player, a video player, an entertainment unit, a navigation device, a communications device, a PDA, a fixed location data unit, or a computer.

The first signal reproduction circuitry 702 may receive the low-band bit stream 142 of FIG. 1 and may be configured to generate a reproduced first signal 780 (e.g., a reproduced version of the first signal 180 of FIGS. 1-2, a reproduced version of the harmonically extended signal 480 of FIG. 4, a reproduced version of the high-band excitation signal 580 of FIG. 5, a reproduced version of the synthesized high-band signal 680 of FIG. 6, or any combination thereof) based on the low-band bit stream 142. For example, the first signal reproduction circuitry 702 may include similar components included in the low-band analysis module 130 of FIG. 1. In addition, the first signal reproduction circuitry 702 may include components similar to components included in the high-band analysis module 150 of FIG. 1. The reproduced first signal 780 may be provided to the frequency domain gain shape adjuster 792.

Frequency domain gain shape parameters, such as the frequency domain gain shape parameters 242 of FIG. 2, may also be provided to the frequency domain gain shape adjuster 792. For example, the high-band side information 172 of FIG. 1 may include data representing the frequency domain gain shape parameters 242 and may be transmitted to the system 700. The frequency domain gain shape adjuster 792 may be configured to adjust the reproduced first signal 780 based on the frequency domain gain shape parameters 242 to generate an adjusted reproduced first signal 744. In a particular embodiment, the frequency domain gain shape adjuster 792 may operate in a substantially similar manner as the frequency domain gain shape adjuster 192 of FIGS. 1-2. The adjusted reproduced first signal 744 may be provided to high-band signal reproduction circuitry 796.

The high-band signal reproduction circuitry 796 may perform temporal/frame gain adjustment, synthesis filtering, or any combination thereof, to generate a reproduced high-band signal 724. The reproduced high-band signal 724 may be a reproduced version of the high-band signal 124 of FIG. 1.

The system 700 of FIG. 7 may reproduce the high-band signal 124 using the reproduced first signal 780 and the frequency domain gain shape parameters 242. Using the frequency domain gain shape parameters 242 may improve accuracy of reproduction by adjusting the reproduced first signal 780 based on energy of particular sub-bands detected at the speech encoder.

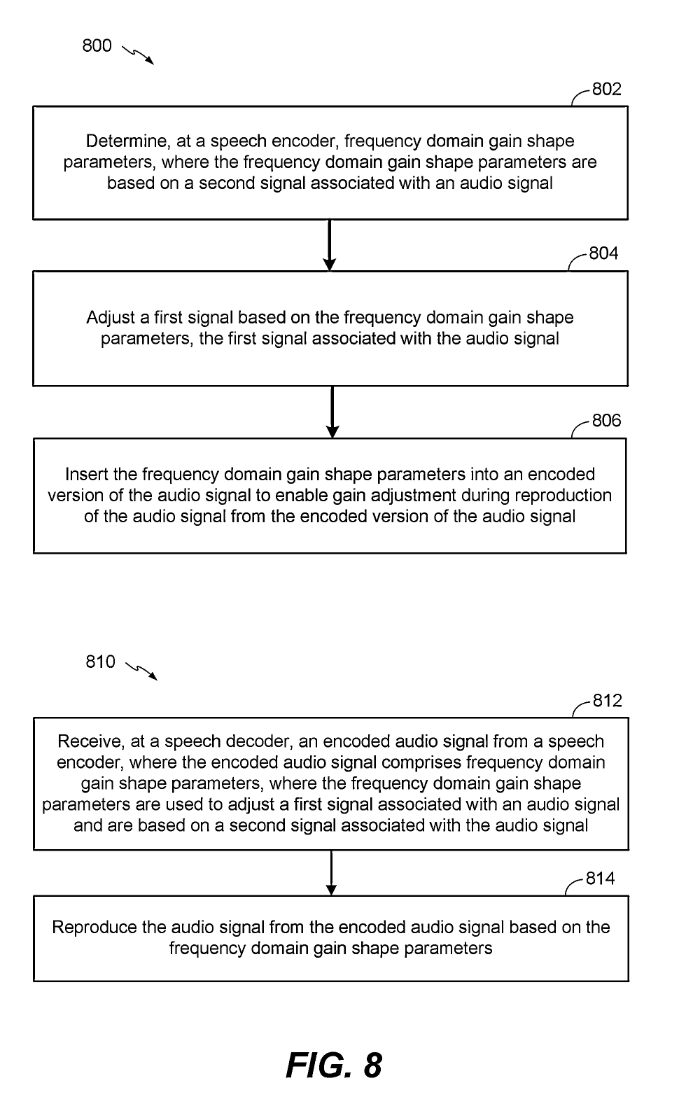

Referring to FIG. 8, flowcharts of particular embodiments of methods 800, 810 of using frequency domain gain estimations for high-band reconstruction are shown. The first method 800 may be performed by the system 100 of FIG. 1, the frequency domain gain shape estimator 190 of FIGS. 1-2, the frequency domain gain shape adjuster 192 of FIGS. 1-2, and the systems 400-600 of FIGS. 4-6. The second method 810 may be performed by the system 700 of FIG. 7.

The first method 800 includes determining, at a speech encoder, frequency domain gain shape parameters, at 802. The frequency domain gain shape parameters are based on a second signal associated with an audio signal. For example, the frequency domain gain shape estimator 190 of FIG. 1 may determine frequency domain gain shape parameters (e.g., the frequency domain gain shape parameters 242 of FIG. 2) based on the first signal 180 and based on the second signal 182. In a first embodiment, the first signal 180 may correspond to the harmonically extended signal 480 of FIG. 4, and the second signal 182 may correspond to the high-band residual signal 482 of FIG. 4. In a second embodiment, the first signal 180 may correspond to the high-band excitation signal 580 of FIG. 5, and the second signal 182 may correspond to the high-band residual signal 482 of FIG. 5. In a third embodiment, the first signal 180 may correspond to the synthesized high-band signal 680 of FIG. 6, and the second signal 182 may correspond to the high-band signal 124 of FIG. 6. In a particular embodiment, multiple frequency domain gain shape parameters may be determined, at 802. For example, first frequency domain gain shape parameters (e.g., the frequency domain gain shape parameters 442 of FIG. 4) may be generated at a first stage, second frequency domain gain shape parameters (e.g., the frequency domain gain shape parameters 542 of FIG. 5) may be generated at a second stage, and third frequency domain gain shape parameters (e.g., the frequency domain gain shape parameters 642 of FIG. 6) may be generated at a third stage.

A first signal may be adjusted based on the frequency domain gain shape parameters, at 804. The first signal may be associated with the audio signal. For example, referring to FIG. 1, the frequency domain gain shape adjuster 192 may adjust the first signal 180 based on the frequency domain gain shape parameters. As a first illustrative non-limiting example, the frequency domain gain shape adjuster 192 may adjust the harmonically extended signal 480 of FIG. 4 based on the frequency domain gain shape parameters 442 to generate the adjusted harmonically extended signal 444. As a second illustrative non-limiting example, the frequency domain gain shape adjuster 192 may adjust the high-band excitation signal 580 of FIG. 5 based on the frequency domain gain shape parameters 542 to generate the adjusted high-band excitation signal 544. As a third illustrative non-limiting example, the frequency domain gain shape adjuster 192 may adjust the synthesized high-band signal 680 of FIG. 6 based on the frequency domain gain shape parameters 642 to generate the adjusted synthesized high-band signal 644.

The frequency domain gain shape parameters (or a representation thereof) may be inserted into an encoded version of the audio signal to enable high-band excitation adjustment during reproduction of the audio signal from the encoded version of the audio signal, at 806. For example, the high-band side information 172 of FIG. 1 may include (or may represent) the frequency domain gain shape parameters 242. The multiplexer 170 may insert the frequency domain gain shape parameters 242 (or a representation thereof) into the bit stream 199, and the bit stream 199 may be transmitted to a decoder (e.g., the system 700 of FIG. 7). The frequency domain gain shape adjuster 792 of FIG. 7 may adjust the reproduced first signal 780 based on the frequency domain gain shape parameters 242 to generate the adjusted reproduced first signal 744.

In a particular embodiment, the first method 800 may include determining a sampling rate for gain shape estimation based on characteristics of the audio signal and determining sub-parameters for gain shape estimation based on characteristics of the audio signal. For example, the multi-domain tiling modules 414, 614 may generate tiling mode indication signals 416, 616 that correspond to a higher time-resolution (e.g., a relatively high sampling rate yielding a larger number of samples per frame) and a lower frequency resolution (e.g., a relatively smaller number of sub-bands) in response to a determination that the high-band residual signal 482 and the high-band signal 124, respectively, correspond to a time-localized transient attack sound or a percussive sound. Alternatively, the multi-domain tiling modules 414, 614 may generate tiling mode indication signals 416, 616 that correspond to a lower time-resolution (e.g., a relatively lower sampling rate yielding a small number of samples per frame) and a higher frequency resolution (e.g., a relatively larger number of sub-bands) in response to a determination that the high-band residual signal 482 and the high-band signal 124, respectively, correspond to sounds having rich harmonics (e.g., human speech).

The second method 810 may include receiving, at a speech decoder, an encoded audio signal from a speech encoder, at 812. The frequency domain gain shape parameters are used to adjust a first signal associated with an audio signal and are based on a second signal associated with the audio signal. The encoded audio signal may include the frequency domain gain shape parameters 242 based on the first signal 180 generated at the speech encoder and the second signal 182 generated at the speech encoder.

An audio signal may be reproduced from the encoded audio signal based on the frequency domain gain shape parameters, at 814. For example, the frequency domain gain shape adjuster 792 of FIG. 7 may adjust the reproduced first signal 780 based on the frequency domain gain shape parameters 242 to generate the adjusted reproduced first signal 744.

The methods 800, 810 of FIG. 8 may improve energy correlation between the first signal 180 and the second signal 182. For example, during frequency domain gain shaping, energy levels of sub-bands of the first signal 180 may be adjusted to approximate energy levels of corresponding sub-bands of the second signal 182 based on frequency domain gain shape parameters. Adjusting the first signal 180 may improve gain shape estimation and reduce audible artifacts during high-band reconstruction of the input audio signal 102. The frequency domain gain shape parameters may be transmitted to a decoder to reduce audible artifacts during high-band reconstruction of the input audio signal 102.

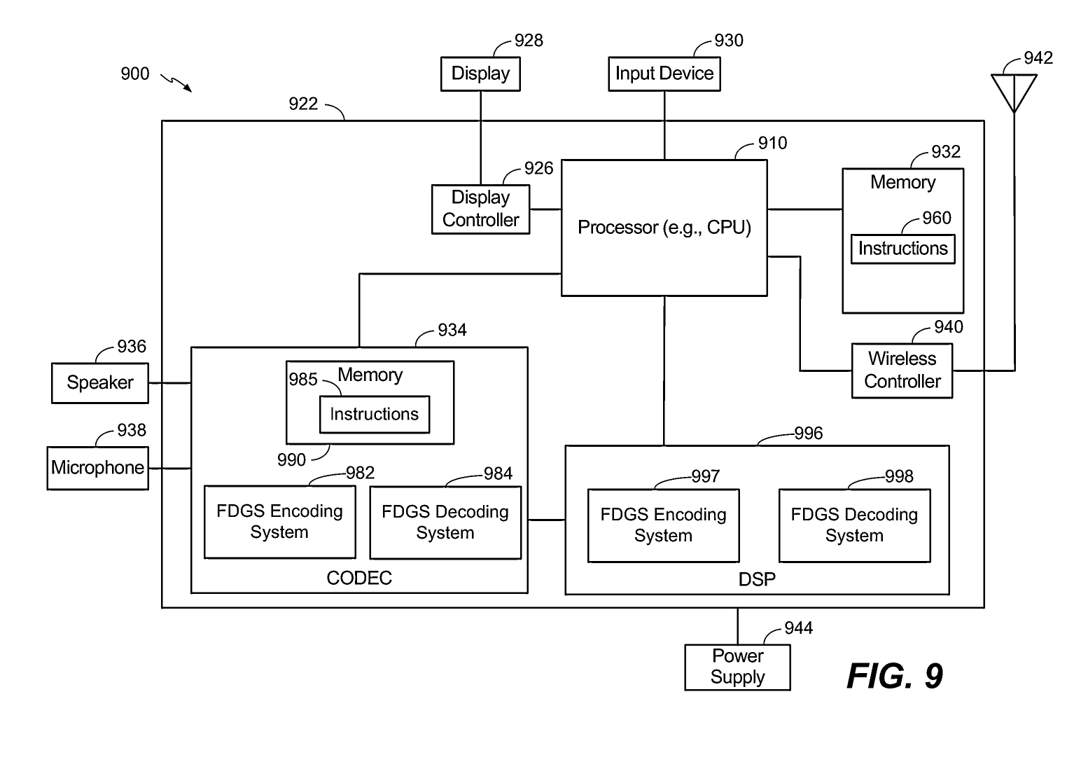

In particular embodiments, the methods 800, 810 of FIG. 8 may be implemented via hardware (e.g., a FPGA device, an ASIC, etc.) of a processing unit, such as a central processing unit (CPU), a DSP, or a controller, via a firmware device, or any combination thereof. As an example, the methods 800, 810 of FIG. 8 can be performed by a processor that executes instructions, as described with respect to FIG. 9.

Referring to FIG. 9, a block diagram of a particular illustrative embodiment of a wireless communication device is depicted and generally designated 900. The device 900 includes a processor 910 (e.g., a CPU) coupled to a memory 932. The memory 932 may include instructions 960 executable by the processor 910 and/or a CODEC 934 to perform methods and processes disclosed herein, such as one or both of the methods 800, 810 of FIG. 8.

In a particular embodiment, the CODEC 934 may include a frequency domain gain shape (FDGS) encoding system 982 and a FDGS decoding system 984. In a particular embodiment, the FDGS encoding system 982 includes one or more components of the system 100 of FIG. 1, the frequency domain gain shape estimator 190 of FIG. 2, the frequency domain gain shape adjuster 192 of FIG. 2, and/or one or more components of the systems 400-600 of FIGS. 4-6. For example, the FDGS encoding system 982 may perform encoding operations associated with the system 100 of FIG. 1, the frequency domain gain shape estimator 190 of FIG. 2, the frequency domain gain shape adjuster 192 of FIG. 2, the systems 400-600 of FIGS. 4-6, and the method 800 of FIG. 8. In a particular embodiment, the FDGS decoding system 984 may include one or more components of the system 700 of FIG. 7. For example, the FDGS decoding system 984 may perform decoding operations associated with the system 700 of FIG. 7 and the method 810 of FIG. 8.

The FDGS encoding system 982 and/or the FDGS decoding system 984 may be implemented via dedicated hardware (e.g., circuitry), by a processor executing instructions to perform one or more tasks, or a combination thereof. As an example, the memory 932 or a memory 990 in the CODEC 934 may be a memory device, such as a random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). The memory device may include instructions (e.g., the instructions 960 or the instructions 985) that, when executed by a computer (e.g., a processor in the CODEC 934 and/or the processor 910), may cause the computer to perform at least a portion of one of the methods 800, 810 of FIG. 8. As an example, the memory 932 or the memory 990 in the CODEC 934 may be a non-transitory computer-readable medium that includes instructions (e.g., the instructions 960 or the instructions 995, respectively) that, when executed by a computer (e.g., a processor in the CODEC 934 and/or the processor 910), cause the computer perform at least a portion of one of the method 800, 810 of FIG. 8.

The device 900 may also include a DSP 996 coupled to the CODEC 934 and to the processor 910. In a particular embodiment, the DSP 996 may include a FDGS encoding system 997 and a FDGS decoding system 998. In a particular embodiment, the FDGS encoding system 997 includes one or more components of the system 100 of FIG. 1, the frequency domain gain shape estimator 190 of FIG. 2, the frequency domain gain shape adjuster 192 of FIG. 2, and/or one or more components of the systems 400-600 of FIGS. 4-6. For example, the FDGS encoding system 997 may perform encoding operations associated with the system 100 of FIG. 1, the frequency domain gain shape estimator 190 of FIG. 2, the frequency domain gain shape adjuster 192 of FIG. 2, the systems 400-600 of FIGS. 4-6, and the method 800 of FIG. 8. In a particular embodiment, the FDGS decoding system 998 may include one or more components of the system 700 of FIG. 7. For example, the FDGS decoding system 998 may perform decoding operations associated with the system 700 of FIG. 7 and the method 810 of FIG. 8.

FIG. 9 also shows a display controller 926 that is coupled to the processor 910 and to a display 928. The CODEC 934 may be coupled to the processor 910, as shown. A speaker 936 and a microphone 938 can be coupled to the CODEC 934. For example, the microphone 938 may generate the input audio signal 102 of FIG. 1, and the CODEC 934 may generate the output bit stream 199 for transmission to a receiver based on the input audio signal 102. For example, the output bit stream 199 may be transmitted to the receiver via the processor 910, a wireless controller 940, and an antenna 942. As another example, the speaker 936 may be used to output a signal reconstructed by the CODEC 934 from the output bit stream 199 of FIG. 1, where the output bit stream 199 is received from a transmitter (e.g., via the wireless controller 940 and the antenna 942).

In a particular embodiment, the processor 910, the display controller 926, the memory 932, the CODEC 934, and the wireless controller 940 are included in a system-in-package or system-on-chip device (e.g., a mobile station modem (MSM)) 922. In a particular embodiment, an input device 930, such as a touchscreen and/or keypad, and a power supply 944 are coupled to the system-on-chip device 922. Moreover, in a particular embodiment, as illustrated in FIG. 9, the display 928, the input device 930, the speaker 936, the microphone 938, the antenna 942, and the power supply 944 are external to the system-on-chip device 922. However, each of the display 928, the input device 930, the speaker 936, the microphone 938, the antenna 942, and the power supply 944 can be coupled to a component of the system-on-chip device 922, such as an interface or a controller.

In conjunction with the described embodiments, a first apparatus is disclosed that includes means for determining frequency domain gain shape parameters. The frequency domain gain shape parameters may be based on a second signal associated with an audio signal. For example, the means for determining the frequency domain gain shape parameters may include the frequency domain gain shape estimator 190 of FIGS. 1, 2, and 4-6, the multi-domain tiling modules 414, 614 of FIGS. 4-6, the FDGS encoding system 982 of FIG. 9, the FDGS encoding system 997 of FIG. 9, one or more devices configured to determine the frequency domain gain shape parameters (e.g., a processor executing instructions at a non-transitory computer readable storage medium), or any combination thereof.

The first apparatus may also include means for adjusting a first signal based on the frequency domain gain shape parameters. The first signal may be associated with the audio signal. For example, the means for adjusting the first signal may include the frequency domain gain shape adjuster 192 of FIGS. 1, 2, and 4-6, the FDGS encoding system 982 of FIG. 9, the FDGS encoding system 997 of FIG. 9, one or more devices configured to adjust the first signal (e.g., a processor executing instructions stored at a non-transitory computer readable storage medium), or any combination thereof.

The first apparatus may also include means for inserting the frequency domain gain shape parameters into an encoded version of the audio signal to enable gain adjustment during reproduction of the audio signal from the encoded audio signal. For example, the means for inserting the frequency domain gain shape parameters into the encoded version of the audio signal may include the multiplexer 170 of FIG. 1, the FDGS encoding system 982 of FIG. 9, the FDGS encoding system 997 of FIG. 9, one or more devices configured to insert the frequency domain gain parameters into the encoded version of the audio signal, (e.g., a processor executing instructions at a non-transitory computer readable storage medium), or any combination thereof.

In conjunction with the described embodiments, a second apparatus is disclosed that includes means for receiving an encoded audio signal from a speech encoder. The encoded audio signal includes frequency domain gain shape parameters that may be configured to adjust a first signal associated with an audio signal and may be based on a second signal associated with the audio signal. For example, the means for receiving the encoded audio signal may include the first signal reproduction circuitry 702 of FIG. 7, the frequency domain gain shape adjuster 792 of FIG. 7, the FDGS decoding system 984 of FIG. 9, the FDGS decoding system 998 of FIG. 9, one or more devices configured to receive the encoded audio signal, (e.g., a processor executing instructions at a non-transitory computer readable storage medium), or any combination thereof.

The second apparatus may also include means for reproducing an audio signal from the encoded audio signal based on the first gain shape parameters. For example, the means for reproducing the audio signal may include the first signal reproduction circuitry 702 of FIG. 7, the frequency domain gain shape adjuster 792 of FIG. 7, the high-band signal reproduction circuitry 796 of FIG. 7, the FDGS decoding system 984 of FIG. 9, the FDGS decoding system 998 of FIG. 9, one or more devices configured to reproduce the audio signal, (e.g., a processor executing instructions at a non-transitory computer readable storage medium), or any combination thereof.

Those of skill would further appreciate that the various illustrative logical blocks, configurations, modules, circuits, and algorithm steps described in connection with the embodiments disclosed herein may be implemented as electronic hardware, computer software executed by a processing device such as a hardware processor, or combinations of both. Various illustrative components, blocks, configurations, modules, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in a memory device, such as random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). An exemplary memory device is coupled to the processor such that the processor can read information from, and write information to, the memory device. In the alternative, the memory device may be integral to the processor. The processor and the storage medium may reside in an ASIC. The ASIC may reside in a computing device or a user terminal. In the alternative, the processor and the storage medium may reside as discrete components in a computing device or a user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
determining, at a speech encoder, frequency domain gain shape parameters, wherein the frequency domain gain shape parameters are based on a second signal associated with an audio signal;
adjusting a first signal based on the frequency domain gain shape parameters, the first signal associated with the audio signal; and
inserting the frequency domain gain shape parameters into an encoded version of the audio signal to enable gain adjustment during reproduction of the audio signal from the encoded version of the audio signal.

2. The method of claim 1, wherein the first signal corresponds to a high-band excitation signal, and wherein the second signal corresponds to a high-band residual signal.

3. The method of claim 1, wherein the first signal corresponds to a harmonically extended signal, and wherein the second signal corresponds to a high-band residual signal.

4. The method of claim 1, wherein the first signal corresponds to a synthesized high-band signal, and wherein the second signal corresponds to a high-band portion of the audio signal.

5. The method of claim 1, wherein adjusting the first signal comprises boosting or attenuating a particular sub-band of a particular frame or sub-frame of the first signal to approximate an energy level of a corresponding sub-band of a corresponding frame or sub-frame of the second signal.

6. The method of claim 1, further comprising transmitting the frequency domain gain shape parameters to a speech decoder as part of a bit stream.

7. The method of claim 1, wherein determining the frequency domain gain shape parameters comprises:
determining first energy levels for each sub-band in a frame or sub-frame of the first signal; and
determining second energy levels for corresponding sub-bands in a corresponding frame or sub-frame of the second signal;
wherein the frequency domain gain shape parameters are based on ratios of the first energy levels and the second energy levels.

8. The method of claim 7, further comprising:
determining a sampling rate based on a characteristic of the audio signal, wherein a number of frames or sub-frames for the first signal is based on the sampling rate; and
determining sub-band parameters based on the characteristics of the audio signal, wherein a number of sub-bands in each frame or sub-frame of the first signal is based on the sub-band parameters.

9. The method of claim 7, wherein a first bandwidth of a particular sub-band of the first signal is different than a second bandwidth of another sub-band of the first signal.

10. An apparatus comprising:
a frequency domain gain shape estimator configured to determine frequency domain gain shape parameters, wherein the frequency domain gain shape parameters are based on a second signal associated with an audio signal;
a frequency domain gain shape adjuster configured to adjust a first signal based on the frequency domain gain shape parameters, the first signal associated with the audio signal; and
a multiplexer configured to insert the frequency domain gain shape parameters into an encoded version of the audio signal to enable gain adjustment during reproduction of the audio signal from the encoded version of the audio signal.

11. The apparatus of claim 10, wherein the first signal corresponds to a high-band excitation signal, and wherein the second signal corresponds to a high-band residual signal.

12. The apparatus of claim 10, wherein the first signal corresponds to a harmonically extended signal, and wherein the second signal corresponds to a high-band residual signal.

13. The apparatus of claim 10, wherein the first signal corresponds to a synthesized high-band signal, and wherein the second signal corresponds to a high-band portion of the audio signal.

14. The apparatus of claim 10, wherein adjusting the first signal comprises boosting or attenuating a particular sub-band of a particular frame or sub-frame of the first signal to approximate an energy level of a corresponding sub-band of a corresponding frame or sub-frame of the second signal.

15. The apparatus of claim 10, further comprising a transmitter to transmit the frequency domain shape gain parameters to a decoder as part of a bit stream.

16. The apparatus of claim 10, wherein the frequency domain gain shape estimator is configured to:
determine first energy levels for each sub-band in a frame or sub-frame of the first signal; and
determine second energy levels for corresponding sub-bands in a corresponding frame or sub-frame of the second signal;
wherein the frequency domain gain shape parameters are based on ratios of the first energy levels and the second energy levels.

17. The apparatus of claim 16, further comprising a multi-domain tiling system configured to:
determine a sampling rate based on characteristics of the audio signal, wherein a number of frames or sub-frames for the first signal is based on the sampling rate; and
determine sub-band parameters based on the characteristics of the audio signal, wherein a number of sub-bands in each frame or sub-frame of the first signal is based on the sub-band parameters.

18. The apparatus of claim 16, wherein a first bandwidth of a particular sub-band of the first signal is different than a second bandwidth of another sub-band of the first signal.

19. An apparatus comprising:
means for determining frequency domain gain shape parameters, wherein the frequency domain gain shape parameters are based on a second signal associated with an audio signal;
means for adjusting a first signal based on the frequency domain gain shape parameters, the first signal associated with the audio signal; and
means for inserting the frequency domain gain shape parameters into an encoded version of the audio signal to enable gain adjustment during reproduction of the audio signal from the encoded version of the audio signal.

20. The apparatus of claim 19, wherein the first signal corresponds to a high-band excitation signal, and wherein the second signal corresponds to a high-band residual signal.

21. The apparatus of claim 19, wherein the first signal corresponds to a harmonically extended signal, and wherein the second signal corresponds to a high-band residual signal.

22. The apparatus of claim 19, wherein the first signal corresponds to a synthesized high-band signal, and wherein the second signal corresponds to a high-band portion of the audio signal.

23. The apparatus of claim 19, wherein adjusting the first signal comprises boosting or attenuating a particular sub-band of a particular frame or sub-frame of the first signal to approximate an energy level of a corresponding sub-band of a corresponding frame or sub-frame of the second signal.

24. The apparatus of claim 19, further comprising means for transmitting the frequency domain gain shape parameters to a speech decoder as part of a bit stream.

25. The apparatus of claim 19, wherein determining the frequency domain gain shape parameters comprises:
determining first energy levels for each sub-band in a frame or sub-frame of the first signal; and
determining second energy levels for corresponding sub-bands in a corresponding frame or sub-frame of the second signal;
wherein the frequency domain gain shape parameters are based on ratios of the first energy levels and the second energy levels.

26. The apparatus of claim 25, further comprising:
means for determining a sampling rate based on a characteristic of the audio signal, wherein a number of frames or sub-frames for the first signal is based on the sampling rate; and
means for determining sub-band parameters based on the characteristics of the audio signal, wherein a number of sub-bands in each frame or sub-frame of the first signal is based on the sub-band parameters.

27. An apparatus comprising:
a decoder configured to:
receive an encoded audio signal from an encoder, wherein the encoded audio signal comprises frequency domain gain shape parameters, wherein the frequency domain gain shape parameters are used to adjust a first signal associated with an audio signal, and wherein the frequency domain gain shape parameters are based on a second signal associated with the audio signal; and
reproduce the audio signal from the encoded audio signal based on the frequency domain gain shape parameters.

28. The apparatus of claim 27, wherein the decoder comprises:
circuitry configured to reproduce the first signal based at least in part on a low-band bit stream of the encoded audio signal; and
a frequency domain gain shape adjuster configured to adjust the reproduced first signal based on the frequency domain gain shape parameters.

29. The apparatus of claim 27, wherein the first signal corresponds to a high-band excitation signal, and wherein the second signal corresponds to a high-band residual signal.

30. The apparatus of claim 27, wherein the first signal corresponds to a synthesized high-band signal, and wherein the second signal corresponds to a high-band portion of the audio signal.
